(19) United States
(12) Patent Application Publication
(10) Pub. No.: US 2012/0269939 A1
(43) Pub. Date: Oct. 25, 2012

(54) Cereal Binder Compositions and Methods for Making Cereal Bars and Cereal Clusters

(75) Inventors: Gary Lee Hahn, Twin Falls, ID (US); Loren S. Ward, Twin Falls, ID (US)

(73) Assignee: GLANBIA NUTRITIONALS (IRELAND), LTD., Kilkenny (IE)

(21) Appl. No.: 13/451,531

(22) Filed: Apr. 19, 2012

Related U.S. Application Data
(60) Provisional application No. 61/477,011, filed on Apr. 19, 2011.
(60) Provisional application No. 61/529,229, filed on Aug. 30, 2011.

(51) Int. Cl. A23L 1/164; A23P 1/02; A23J 1/20

(52) U.S. Cl. 426/285; 426/583

(57) ABSTRACT

Disclosed are cereal binder compositions having reduced carbohydrate content as compared to present carbohydrate binders. Also disclosed are methods for producing agglomerated cereal products using binders comprising a substantially gluten-free protein in combination with carbohydrate.

This application claims the benefit of priority of earlier-filed U.S. Provisional Patent Applications 61/477,011 (filed Apr. 19, 2011) and 61/529,229 (filed Aug. 30, 2011), the disclosures of which are incorporated herein by reference where allowed by applicable law.

### FIELD OF THE INVENTION

The invention relates to compositions for use as binders for the production of cereal clusters, cereal bars, and other agglomerated cereal-based products, and methods for making cereal clusters, cereal bars, and other agglomerated cereal-based products using those binder compositions.

### BACKGROUND OF THE INVENTION

Cereal clusters and cereal bars are popular food products. In order to successfully create these products, binders are used to hold the cereal particles together. Successful preparation of cereal clusters and/or bars requires that the manufacturer utilize one or more binders that, when incorporated into the clusters, produce a product with appropriate water activity, moisture content, and ability to form crispy clusters with limited breakage, and limited production of fines. U.S. Pat. No. 6,800,312, for example, describes a method for making cereal clusters using a starch binder. U.S. Pat. No. 7,097,870 discloses the use of a soy protein/fat and hydrated gelatin binder. U.S. Patent Application Publication number 20070014914A1 discloses the use of modified wheat protein (gluten) as a binder. A binder comprising a blend of polydextrose, crystalline fructose, and glycerin is disclosed in U.S. Patent Application Publication number 20110039004A1, and a blend comprising inulin, dextrin, citrus fiber, and cookie dough is disclosed in U.S. Patent Application Publication number 20090017168A1. U.S. Pat. No. 4,055,669 discloses a binder comprising fat, protein, and carbohydrate, wherein the fat comprises from ⅓ to 85% of the binder composition and the binder comprises the bulk of the total weight of the final product (e.g., 2:1 binder/cereal ratio, 7:1 binder/cereal ratio, etc.).

Chewy cereal bars are generally formed of cereal components such as granola, and at least one binder to hold the cereal components together. Consumers prefer that the cereal be crisp and the binder be flexible to provide the chewy texture. In order to achieve this result, the water activity of the binder should generally be less than about 0.58. Sugars, and particularly sugar syrups, are often used as binders for chewy cereal bars because they achieve the desired flexibility, while having the desired water activity. Although they are quite useful for holding the cereal components together, sugar syrups may have undesirable glycemic effects and increase the number of calories in the product. Therefore, many companies have tried to develop reduced sugar products, often by using added ingredients, but generally with limited success. Other emulsification ingredients to combine the water and the oil, such as lecithin, may be used, but lecithin—particularly lecithin derived from soy—may be less desirable because a significant percentage of the population is at risk for experiencing an allergic reaction to soy lecithin, particularly if present in the product in significant amounts. Wheat gluten has been used as a binder for some chewy granola bar products, but many people are also allergic to gluten and must avoid products containing it.

Sugar alcohols have been used as an alternative for at least a portion of the sugar usually incorporated into a chewy cereal product binder, but these products often have reduced shelf life, undesirable texture, dryness, and/or reduced stability, particularly in cereal/granola bar products as compared to their higher-sugar counterparts. Consumer acceptance of these products is generally reduced over that of products made by using sugars/sugar syrups. Therefore, additives have been investigated for maintaining softness and extending the shelf life of chewy cereal products. One such additive is sodium polyphosphate, which, when added at a level of about 0.3%, has been shown to maintain softness of chewy cereal products for an increased time.

Use of many sugar alcohols may also be limited because they tend to produce gas, bloating, and/or diarrhea if consumed at sufficient levels. Alternatives are therefore needed for the formation of chewy cereal bars to produce products that are more appropriate for a broad segment of the population, many of whom may have food ingredient sensitivities, while gaining broad consumer acceptance.

The ingredients used to produce a binder composition form a part of the final food product. Binder compositions should produce the physical properties desired in a crunchy cereal cluster or chewy cereal bar, for example, while meeting consumer preference and nutritional needs. For example, it would be desirable to decrease the amount of sugar needed to formulate a binder composition and it would be preferable to exclude the use of gluten because binders may be needed for gluten-free products. These goals would be even more beneficial if they result in the formulation of binder ingredients that allow the texture and moisture content of a product to be varied (producing a range of products from chewy to crisp, for example) and produce a product with desirable taste, texture, cluster integrity, and other properties desirable in a cereal cluster and/or cereal bar product.

### SUMMARY OF THE INVENTION

The invention relates to a composition comprising a substantially gluten-free cereal binder comprising whey protein and at least one carbohydrate. In various aspects of the invention, the carbohydrate comprises at least one sugar. In some aspects, the composition is both substantially gluten-free and substantially fat-free.

The invention also relates to a method for reducing the amount of carbohydrate needed to maintain cluster strength in a cereal product, the method comprising incorporating into a cereal binder at least one substantially gluten-free protein to provide protein at a level of from about 0.5 percent to about 9 percent of the total weight of the cereal binder. In some aspects, the protein level is from about 2 to about 6 percent of the total weight of the cereal binder. In certain aspects of the invention, the substantially gluten-free protein is whey protein. In some aspects of the invention, whey protein may be provided, for example, in the form of whey protein concentrate and/or whey protein isolate. In various aspects, the protein may also comprise other milk proteins, soy protein, or other food proteins known to those of skill in the art.

The invention also relates to a method for incorporating a binder into an agglomerated cereal product, the method comprising admixing at least one cereal product with a binder composition comprising at least one substantially gluten-free protein and carbohydrate comprising at least one sugar. In certain aspects of the invention, the process of forming the cluster may be improved by adding a first step comprising applying oil or fat to the surface of at least one cereal product to be incorporated into the agglomerated cereal product to limit absorption of the binder composition into the cereal product.

In another aspect, the invention relates to compositions comprising binders for chewy cereal products, such as chewy cereal bars or clusters, including, for example, granola bars, breakfast bars, cereal bars, rice cakes, corn cakes, and popcorn cakes, those binders being formulated to comprise at least one sugar syrup and at least one milk protein, the protein comprising from about 0.2% to about 6% of the binder by weight. In various aspects, the protein may comprise from about 0.7 to about 6 percent of the binder, by weight. In various aspects, the invention relates to compositions comprising at least one sugar and at least one milk protein, admixed to form a binder for chewy clustered cereal products.

The invention also relates to a method for making a binder for chewy clustered cereal products, the method comprising the steps of hydrating whey protein at a level of about 25 to about 35 percent protein in water, and admixing the hydrated whey protein with at least one sugar syrup to produce a mixture having a viscosity solids range of from about 65 to about 85 percent, and even more preferably from about 70 to about 78 percent.

The invention also relates to a method for making a reduced-sugar binder for clustered cereal products, the method comprising dissolving at least one milk protein in water at a temperature of from about 70° to 140° F., and even more preferably 110° F. to about 130° F., followed by the step of admixing the hydrated protein with at least one sugar syrup at a temperature of from about 70° to 140° F., and even more preferably about 110° to 130° F. In aspects of the invention, the step of hydrating the protein may be performed by using a liquid milk protein composition, such as, for example, a liquid whey protein product. Preferably, the step of admixing the protein and sugar syrup is performed using shear and vortex or high-shear inline mixing. This method produces a binder that may be used to produce clustered cereal products having reduced sugar content, while maintaining the desired water activity to retain the desirable texture of the cereal.

The invention also relates to a method for improving the shelf-life, texture, and palatability of chewy cereal products, the method comprising incorporating into a sugar syrup binder at least one milk protein. In various aspects, the at least one milk protein comprises at least one hydrated whey protein.

### BRIEF DESCRIPTION OF THE DRAWINGS

FIG. 1 is a graph which illustrates the breaking force required to break a cluster as carbohydrate is decreased

FIG. 2 is a graph which illustrates that the addition of less than 10% (by weight of the binder composition) of protein can protect the cluster from breakage when carbohydrate is reduced by as much as 50%.

FIG. 3 is a graph that illustrates that sensory crunch is significantly decreased as carbohydrate levels in the binder are reduced.

FIG. 4 is a graph that show that crunch can be maintained, even in the presence of carbohydrate reduction, by the addition of whey protein.

### DETAILED DESCRIPTION

The inventors have developed substantially gluten-free cereal binder compositions comprising whey protein and at least one carbohydrate comprising at least one sugar. These binder compositions may be used to produce various agglomerated cereal products, such as cereal clusters and cereal bars. By varying the binder composition formulation as disclosed herein, reduced-sugar binders may be produced for crunchy agglomerated cereal products or chewy agglomerated cereal products. Compositions of the invention may comprise at least a 50 percent reduction in sugar content over presently-available binder compositions in the cereal industry. Cluster strength is maintained by the addition of from about 0.2 to about 9 percent protein (e.g., milk-derived protein such as whey protein) to a binder composition with a sugar content that has been reduced by 50 percent, as compared to standard binder compositions in the art. Clusters of especially desirable strength may, for example, be formed using about 2 to about 7 percent protein.

As used herein, a “binder” or “cereal binder” is intended to mean a cereal adhesive formula for adhering or clustering whole or crushed pieces of cereals that provide multiple contact points for a sugar/protein binder, cereals comprising, for example, commercially-available cereals (e.g., Cheerios® (General Mills), Corn Flakes® (Kelloggs), Special K® (Kelloggs), etc.), whole grains and/or nuts (e.g., oats, flax seed, almonds, etc.), and other ingredients for forming cereal product-based clusters, bars, and other composite cereal products. “Substantially gluten-free” is intended to denote a composition having no more than trace amounts of wheat protein isolate, or gluten. “Reduced sugar” refers to a cereal binder in which the amount of carbohydrate necessary to maintain cluster strength and cluster integrity is reduced, this reduction generally being approximately 25% or greater. “Substantially lecithin-free” is intended to denote a binder product to which lecithin has not been added. “Whey protein” may include, for example, milk protein isolate (MPI) containing whey, whey protein isolate (WPI), whey protein concentrate (WPC), and/or combinations thereof “Milk protein,” as used herein, denotes a protein fraction derived from milk. Milk contains a variety of proteins, including, for example, caseins and they whey proteins β-microglobulin, α-lactalbumin, and lactoferrin. Milk proteins are isolated by various means, depending upon the specific fraction that is desired to be isolated. Such protein fractions include, but are not limited to, milk protein isolate, milk protein concentrate, casein, whey protein, whey protein isolate, and/or whey protein concentrate. “Reduced carbohydrate” refers to a cereal binder in which the amount of carbohydrate necessary to maintain cluster strength and cluster integrity is reduced by from about 25% to about 50% by the addition of whey protein to the cereal binder. “Substantially fat-free” is intended to mean that a binder of the invention contributes about 0.5 grams, or less than about 0.5 grams, of fat per 24 gram serving of agglomerated cereal product to which the binder has been added.

The terms “comprising” and “comprises” are used herein, but it is to be understood that the terms “consisting of” and “consisting essentially of” may also be used. Where ranges are provided, it is intended that they include sub-ranges thereof.

In certain aspects of the invention, whey protein (milk protein) comprises from about 0.2 to about 6 percent of the binder composition, by weight, for chewy agglomerated cereal products and from about 0.5 to about 9 percent, by weight, for agglomerated cereal clusters. Particularly desirable cluster attributes have been produced using from about 2 to about 6 percent whey protein, by weight. Sources of whey protein are well-known to those of skill in the art. Whey protein isolate and/or whey protein concentrate, for example, have been shown by the inventors to provide excellent results in the preparation of a cereal binder that provides desirable texture, cluster strength, organoleptic properties, and reduction of fines.

The invention also relates to a method for reducing the amount of carbohydrate needed to maintain cluster strength in a cereal product, the method comprising adding to a cereal binder a substantially gluten-free protein at a level of from about 0.2 percent to about 9 percent of the total weight of the cereal binder. In certain aspects of the invention, the substantially gluten-free protein is whey protein. In some aspects of the invention, whey protein may be provided, for example, in the form of whey protein concentrate and/or whey protein isolate. In various aspects, however, the substantially gluten-free protein may comprise soy protein or other non-wheat proteins, either alone or in combination with whey protein. Cluster strength generally requires that a cereal binder comprise at least a significant portion of carbohydrate. In fact, clusters may be formed using carbohydrate applied as a liquid or syrup, alone. However, the inventors have discovered that incorporating whey protein, whey protein isolate, and/or whey protein concentrate maintains cluster strength when carbohydrate is reduced by as much as about 50%. Adding the protein to a cereal binder also maintains cluster integrity and sensory crunch in clusters produced with lower-carbohydrate binders. The inventors' experiments have demonstrated that as much as a 50% reduction in carbohydrate/sugar may be compensated for, in terms of desirable properties produced by carbohydrate inclusion in a cereal binder, by the addition of from about 2 to about 6 percent whey protein concentrate, for example, expressed as a percentage of total finished weight of the cereal. In a 25% to 50% carbohydrate reduction, 5% whey protein concentrate produced a product with a 0.32 to 0.34 water activity and a texture of 4 kg force.

The invention also relates to a method for incorporating a binder into an agglomerated cereal product, the method comprising admixing at least one cereal product with a binder composition comprising a substantially gluten-free protein and at least one carbohydrate. In certain aspects of the invention, the organoleptic properties of a cereal cluster, for example, may be improved by adding a first step comprising applying oil or fat to the surface of at least one cereal product to be incorporated into the agglomerated cereal product, to limit absorption of the binder composition (and particularly the aqueous portion of the binder) into the cereal product. The substantially gluten-free protein will preferably be whey protein, which has demonstrated superior results, but may also comprise soy protein or other non-wheat proteins, either alone or in combination with whey protein. In various aspects the at least one carbohydrate will comprise at least one sugar.

Binder compositions containing, for example, starch, soy protein/fat and hydrated gelatin, modified wheat protein (gluten), a blend of polydextrose, crystalline fructose, and glycerin, or a blend comprising inulin, dextrin, citrus fiber, and cookie dough, have been previously described. These types of compositions, however, contain ingredients that may be undesirable in certain products (such as gluten), and/or may contain higher than desirable levels of fat or starch. Some binder compositions, such as that disclosed in U.S. Pat. No. 4,055,669, comprising fat, protein, and carbohydrate, wherein the fat comprises from ⅓ to 85% of the binder composition and the binder comprises the bulk of the total weight of the final product (e.g., 2:1 binder/cereal ratio, 7:1 binder/cereal ratio, etc.).

The inventors realized that it would be desirable to produce a product that would require the use of less binder and more cereal product, as well as less sugar, less fat, and, preferably, a low enough level of gluten to qualify the product for use in gluten-free agglomerated cereal products. The binder composition of the present invention utilizes the combination of whey protein and carbohydrate to produce a binder that is substantially gluten-free. While higher levels of fat may be incorporated into the binder composition, a more preferred composition would be substantially fat-free. By combining the protein and carbohydrate so that the protein comprises from about 2 to about 7 percent of the total product weight, the inventors have discovered that it is possible to decrease the amount of carbohydrate (i.e., sugar) needed to produce clusters of the desired cluster strength and organoleptic properties. Utilizing this binder composition and the method for forming agglomerated cereal products described herein, it is possible to produce substantially gluten-free, lower fat products, as well. For example, even if the additional step of coating the cereal product with oil is performed before applying the binder composition, the total fat content of the binder composition and the oil coating is less than that of most previously-described binder compositions and methods. The binder composition of the present invention also allows the binder to be used at a percentage by weight of the total agglomerated cereal product of about 35% or less, whereas compositions such as that described in U.S. Pat. No. 4,055,669, incorporate the binder composition at a ratio of 7 parts binder to 3 parts cereal (Examples 2 and 5) or 2 parts binder to 1 part cereal (Example 4).

Compositions and methods of the invention may be used in a variety of products including, for example, any food with water activity less than 0.6 such as cereals, bars, snacks, dog and cat food, etc. The inventors have noted several beneficial properties produced by the binder composition of the present invention.

Whereas products in experiments 17 and 18 were baked at 317° F. for 13 minutes, the full factorial experiments 1-12 were baked for 317° F. for 15.5 minutes. Products containing protein maintained a moisture level above 3.5%, while still maintaining desirable water activity levels.

By using 2-6% protein in the binder composition (expressed as a percentage of the total cereal cluster product weight), cluster strength is maintained at 50 carbohydrate reduction. Reducing carbohydrates usually makes it easier to break a cluster. Lack of protein generally makes it easier to break a cluster, but if 2-6% protein is present, the cluster is strong. If no carbohydrate is present, the protein cannot maintain the cluster texture. Therefore, cluster strength is accomplished by the combination of protein and carbohydrate.

A 100% decrease in carbohydrates lowers water activity. A high percentage of protein also lowers the water activity. For 0-50% carbohydrate reduction, water activity is constant, but water activity drops almost linearly as protein is increased. Water activity can be maintained if 2-4% protein is present at 50-100% carbohydrate (expressed as a percentage by weight of the total cereal cluster product).

The percentage of moisture decreases when carbohydrate is eliminated. The percentage of moisture also decreases when protein is added, almost linearly. However, the percentage of moisture can be maintained at desirable levels by a combination of protein and carbohydrate.

Sensory crunch decreases with elimination of carbohydrates, but is improved by the addition of protein. Sensory crunch decrease at a 0-50% level of carbohydrate reduction can be compensated for by 2-6% protein.

Briefly, to make cereal clusters by the method of the present invention, water is heated to a temperature of 120° F. and agitated with a lightning mixer so that the vortex extends to the top of the container. Protein is then added, dusting it in at the top of the vortex so that the bottom of the vortex is not covered. This step may be performed using a variable speed lightning mixer so the speed is increased as the solids increase. Preferably, the powder should be introduced into the vortex and stirred until it appears to be dissolved, then mixed for an additional 15 minutes to produce a product with improved mouthfeel, which is an important consideration for many consumers. When the protein is in solution, crystallized evaporated cane sugar (solubilized by warming to 120° F. in a water bath or other indirect heating device, such as a hot water exchanger) is added. The protein and surfaces contacting the protein should be kept at or under 130° F. When the evaporated cane sugar has dissolved, brown rice syrup and honey are added. A food-grade oil product such as, for example, canola oil is sprayed on the cereal in a Hobart mixer, stirring every 5 grams of spray. Oil is coated onto the cereal particles first in order to make a barrier so that the protein/sugar solution does not absorb into the cereal.

The mixture is slowly drizzled into a Hobart mixer with a flat paddle on lowest speed. After all liquid is poured into the mixer, mixing is continued for 2 minutes to uniformly coat the cereal product used to form the clusters. The mixture is spread thickly on a thick cookie sheet (e.g., Wilson 38.7×26×1.91 cm) filling into corners, and leveling to 1.91 cm (0.75 inch). Ends are squared with a spatula. For the control product in the inventor's experiments, all liquid was not poured into the mixer, but enough water was added for a 66% solids mixture of evaporated cane sugar and overall sugars were increased by 25%. Coated product was baked at 317° F. for 13 minutes, or until the top browns. Note that protein browns faster than sugar.

Products were also made with flax added. A control was made by adding 31 grams of evaporated cane juice solids, 30.4 grams of brown rice syrup, 15.3 grams of honey, and 16 grams water, which were blended. Cereal (176 grams) was sprayed with oil. The first half of the syrup was added in a Hobart type blender to the 176 grams of cereal and blended. Then 38.6 grams flax were added and blended. The remaining half of syrup was then added, to give a total weight of 350 grams. The blend was baked at 316° F. for 13 minutes.

A product with decreased carbohydrate was made by adding 10.4 grams of whey protein to 25.5 grams of water, and mixing. Then the following were added: 21.7 grams of evaporated cane juice solids, 19.8 grams of brown rice syrup, and 9.95 grams of honey, followed by additional mixing. 167.4 grams of cereal was sprayed with oil. The cereal was added to a Hobart-type blender, and half the syrup was added and mixed. Then 36.7 grams of flax was added and blended. Finally, the second half of the syrup was added and blended. Total weight was 350 grams. The blend was baked at 316° F. for 13 minutes. The product had a 25% sugar reduction relative to the control and 2.2% protein expressed as a percentage of the total mixture. Texture analyzer cut force was 8.14 kg versus the control of 4.95 kg. Water activity was 0.43 versus 0.38 for the control. Milk absorption was 42.5% versus 49.1% for the control. A 25% sugar reduction can therefore be made by the addition of whey protein/flax, with no loss of desirable cluster properties and an increase in cluster strength.

Table 1 shows the nutritional and analytical data for two experimental products and a product control. The product designated as “Trial 17” provided superior and very desirable results. The product designated as “Trial 18” had a chewier, softer consistency.

TABLE 1

| Component | Trial 17 | Trial 18 | Control |
|---|---|---|---|
| Protein/100 grams | 17.6 | 18.1 | 14.1 |
| Sugar/100 grams | 17.9 | 17.3 | 23.1 |
| Moisture | 5.96** | 5.54** | 4.75 |
| Water Activity | 0.26 | 0.32 | 0.29 |
| Knife Peak Force | 3.735 | 2.136*** | 2.734 |

Table 2 lists the ingredients for the binder formula used in each of the products designated as Trial “17,”, “18,” or “Control.

TABLE 2

| | 17 | 17 | 18 | 18 | Control | Control |
|---|---|---|---|---|---|---|
| | Solids | Water | Solids | Water | Solids | Water |
| | (Gm) | (Gm) | (Gm) | (Gm) | (Gm) | (Gm) |
| Evaporated | 6.2 | | 6.2 | | 8.9 | |
| Cane Juice | | | | | | |
| Sugar | | | | | | |
| Water for | | 0.0 | | 0.0 | | 4.6 |
| Evaporated | | | | | | |
| Cane Juice | | | | | | |
| Sugar | | | | | | |
| Brown Rice | 4.8 | 0.8 | 4.8 | 0.8 | 7.4 | 1.3 |
| Syrup | | | | | | |
| Honey | 2.2 | 0.7 | 2.2 | 0.7 | 3.3 | 1.1 |
| Total Sugars | 13.2 | | 13.2 | | 19.6 | |
| Protein | 3.5 | | 4.9 | | 0.0 | |
| Added* | | | | | | |
| Water | | 6.7 | | 10.3 | | |
| Added For | | | | | | |
| Protein* | | | | | | |
| % Protein | 2.25 | | 4.0 | | 0.0 | |
| Added | | | | | | |

Use of milk-derived protein in cereal binders also, based on tests performed by the inventors, provides a pleasant tasting formulation that provides a more preferred flavor in products made with the milk-derived protein-based cereal binder as compared to products made without the milk-derived protein-based cereal binder.

Milk-derived protein in cereal binders, especially when the milk-derived protein is whey protein, also provide additional benefits in that they provide higher levels of branched-chain amino acids, such as leucine. Leucine has been associated with a variety of health benefits, including potentially increasing weight loss and maintaining muscle mass during weight loss. When combined with the fact that the addition of whey protein allows the formulator to reduce the amount of carbohydrate needed to achieve the desired cluster characteristics, this can ultimately provide a significant effect in terms of weight loss and weight maintenance.

Clusters have previously been formed using wheat gluten (wheat protein isolate). The cereal binder compositions of the present invention allow a formulator to produce a cereal binder that is substantially gluten-free. This may be important for formulating gluten-free products. For example, General Mills provides a gluten-free line of Chex® cereals for those who are sensitive to wheat gluten, such as those with celiac disease. By using whey protein, whey protein isolate, whey protein concentrate, etc., for example, substantially gluten-free clusters and/or cereal bars may be formed using the cereal binder of the invention in conjunction with one or more gluten-free cereals, also providing the added benefit of reducing carbohydrate and fat in the binder, and therefore the total product levels of these ingredients as compared to levels found in carbohydrate binders formulated without the added protein.

Reduced sugar cereal bars have been difficult to manufacture and market because reducing the amount of sugar in the binder syrup has typically decreased the desirable texture and shelf-life of the bars. Reduced-sugar chewy cereal bars require a pliability that has been difficult to achieve in a reduced-sugar product, while still retaining the desired texture of the cereal components from which the clustered product is made. The most recently-introduced commercial granola and cereal bars having reduced sugar content utilize sugar alcohols to replace some of the sugar. However, using “sugar alcohols help[s] keep water activity low, but replacing sugars with sugar alcohols can result in production of products with reduced bar stability, textural changes, reduced shelf life, and reduced consumer acceptance” (Burrington, K. J., “U.S. Whey Ingredients in Nutrition Bars and Gels,” U.S. Dairy Export Council Application Monograph, 2007, page 4).

“Chewy cereal products” are products formed by clustering crisp cereals, cereal pieces, whole grains, nuts, and/or other similar ingredients using a binder composition that produces a flexible bar, nugget, or other form of cereal cluster, while maintaining a substantial portion of the crispness of the clustered components. The inventors have developed a reduced-sugar, substantially gluten-free, substantially lecithin-free binder which may be used to produce chewy cereal products such as, for example, granola bars, breakfast bars, cereal bars, rice cakes, corn cakes, and popcorn cakes, while reducing the sugar content of those products as compared to that of similar products that are presently on the market. Using the inventive binder produces a cereal bar, such as a granola bar, which retains the desirable texture, moistness, and shelf-life previously achieved using binders having higher sugar content. Reducing sugars may be eliminated from a 25% reduced-sugar product, for example, using the inventive binder of the invention. Binder compositions for chewy cereal products comprise at least one sugar and at least one milk protein, the at least one milk protein comprising from about 0.2 to about 7 percent of the binder, by weight.

The inventors also disclose here a method for making a binder for chewy cereal products, the method comprising the step of hydrating whey protein at a level of about 25 to about 35 percent protein in water, and admixing the hydrated whey protein with at least one sugar syrup to produce a mixture having a viscosity solids range of from about 65 to about 85 percent, and even more preferably from about 70 to about 78 percent. More specifically, the method for making a binder for chewy cereal products, comprises the steps of hydrating whey protein by dissolving the protein in water at a temperature of from about 70° to 140° F., preferably 110° F. to about 130° F., and admixing the hydrated protein with a sugar syrup at a temperature of from about 70° to 140° F., and more preferably about 110° to 130° F., to produce the binder. In aspects of the invention, the step of hydrating the whey protein may be performed by using a liquid whey protein composition. Preferably, the step of admixing the protein and sugar syrup is performed using shear and vortex or high-shear inline mixing. This method produces a viscous binder that may be used to produce clustered cereal products having reduced sugar content, while maintaining the desired water activity to retain the desirable texture of the cereal.

Cereals are often agglomerating using sugar syrups cooked at 77-90° C. by methods known to those of skill in the art. Such sugar syrups typically comprise one or more of sugars including, but not limited to, dextrose syrup, sucrose, maltodextrin, invert sugar syrup, dextrose, and/or fructose, for example. Binder compositions containing, for example, starch, soy protein/fat and hydrated gelatin, modified wheat protein (gluten), a blend of polydextrose, crystalline fructose, and glycerin, or a blend comprising inulin, dextrin, citrus fiber, and cookie dough, have been previously described. However, these types of compositions contain ingredients that may be undesirable in certain products (such as gluten or lecithin), and/or may contain higher than desirable levels of sugar.

Processes for making chewy granola bars have been previously described in United States Patent Application Publication Numbers 20050053697 and 20070178204, for example. These methods, and others known to those of skill in the art, may be used to form clusters of cereals, dried fruits, nuts, whole grains, candy pieces, chocolate chips, and any other ingredient suitable for incorporation into a chewy nutritional bar or cluster, using the binder composition of the present invention.

Milk proteins, such as whey protein, have previously been incorporated into the dry ingredient component of cereal bars, rather than forming a part of the binder. Although many different ingredients have been utilized in an attempt to produce binders for chewy cereal products which agglomerate (i.e., cluster) crisp ingredients, these binders having decreased sugar content, the inventors have discovered that milk proteins such as whey proteins provide an unexpected functionality in such products because they increase the retention of moistness and chewiness, maintain product shape and texture, and increase shelf life. However, this effect is more pronounced when the protein is admixed with water to hydrate it to a significant level prior to admixing it with the sugars and/or sugar syrups to produce a binder syrup, these syrups generally being cooked at a temperature of from about 77° F. to 91° C., and even more preferably at 80° to about 88° degrees Celsius.

Those of skill in the art know that heating protein in water may result in gelation of the protein. However, heating the protein water, sugar (and optionally, fat) solution of the invention to 185° F. partially denatures the proteins, but does not aggregate them, resulting in a binder that provides a bar that is more stringy, chewy, and soft. In essence, this allows the protein to be in its active conformation prior to exposure to the high temperatures that would usually denature the protein. Although milk protein comprises a variety of functional proteins such as lactoferrin, lactoglobulin, and other proteins having a variety of different functions, the inventors have observed an important functionality for the group of proteins when they are processed in the manner described by the method of the invention. Hydrating the protein prior to admixing with the sugar syrup(s) and cooking the admixture produces a smooth syrup which, if used in chewy cereal bars, will increase consumer preference toward the bars, increase shelf life, improve texture and moisture retention, etc. The inventors have discovered that heating the proteins to denature them after they are admixed with the sugar syrup maintains the functionality of the protein for improving binder efficacy. However, they have also discovered that particular blends of protein, such as the OptiSol 2000™ product from Glanbia Nutritionals, Inc. (Monroe, Wis.), also work well without the denaturation.

The inventors have discovered that hydrating the protein prior to admixing it with the sugar syrup, cooking the sugar syrup to produce a binder containing the milk protein, then mixing the binder with the dry ingredients produces a cereal bar having improved organoleptic properties, better moisture retention, and improved shelf life as compared to cereal bars which are prepared without a binder comprising milk protein and sugar. While not being bound by theory, it is believed that combining the steps of hydrating the protein, then heating in the presence of sugar maintains proper folding to enable greater protein functionality in the product. Preparing the binder in this manner allows the formulator to decrease the amount of sugar without losing the beneficial effects for which the sugar is usually incorporated into such products.

The inventors have demonstrated that particularly effective binder compositions may be made when the protein source is a combination of milk protein concentrate (MPC) and whey protein concentrate (WPC), the milk protein concentrate being present at a range of from about 0.1 to about 30 percent of the MPC/WPC combination and the whey protein concentrate being present at a range of from about 70 to about 99.9 percent of the MPC/WPC combination.

The invention also provides methods for incorporating into agglomerated cereal products having porous surfaces, such as puffed cereals. The inventors have demonstrated that coating the cereal with at least one viscous sugar syrup can seal the porous surface prior to, or during, the agglomeration process. The viscous sugar syrup should be of a pourable viscosity, but viscous enough to be considered “thick syrup” by those of skill in the art. As an example, suitable syrups could be selected by determining whether or not a syrup is pourable at 95 degrees Fahrenheit. Suitable syrups may be selected from the group consisting of, for example, honey, corn syrup, water, soluble corn fiber, fructose, rice syrup, sucrose, brown sugar syrup, and combinations thereof.

Also provided is the disclosure that coating the surface of the cereal components, or of the cluster or bar end-product, for example, with a fine spray of about 80 percent fructose will provide a more shiny, attractive product.

The invention may be further described by means of the following non-limiting examples.

### EXAMPLES

The inventors performed a first set of 18 experiments which varied the sugar level and protein level, using various cereals with the intent to form strong clusters. The control had a full amount of sugar, while the experimental samples had a 25% reduction in sugar with varied protein levels across the various experimental products. Texture, water activity and moisture were analyzed. The first 18 experiments were followed by a full factorial design of 12 experiments which further defined the relationships over 0%, 50%, and 100% carbohydrate reductions, and 0%, 2%, 4%, and 6% protein based upon total cereal with protein and sugar. The clusters were formed by a series of steps. First, water (120° F.) was added to a suitable container and agitated with a lightning mixer so that the vortex extended to the top of the container. Protein was added, dusting it in at the top of the vortex so that the bottom of the vortex was not covered. A variable speed lightning mixer was used and the speed increased as the solids increased. Mixing was completed in less than 15 minutes. When the protein was in solution, evaporated cane sugar was added (in crystallized form, but solubilized by warming to 120° F. in a water bath or other indirect heating such as hot water exchanger). The protein and surfaces in contact with the protein were maintained at less than 130° F. When the evaporated cane sugar was solubilized, brown rice syrup and honey were added. Aerosolized canola oil was sprayed on the cereal in a Hobart, stirring every 5 grams of spray. Protein/sugar or sugar control mixture was drizzled into the Hobart with a flat paddle on the lowest speed. After all liquid was added into the mixer, mixing was continued for 2 minutes to uniformly coat the cereal. The coated cereal was placed on a thick cookie sheet (Wilson 38.7×26×1.91 cm), spreading the cereal into the corners of the pan and leveling to 1.91 cm (0.75 inch). Ends were squared with spatula. For the control, protein was omitted, but enough water was added for a 66% solids mixture of evaporated cane sugar. Overall sugars were increased 25% for control. Baking was performed at 317° F. for 13 minutes or until the top was browned. (Note: protein browns quicker than sugar.)

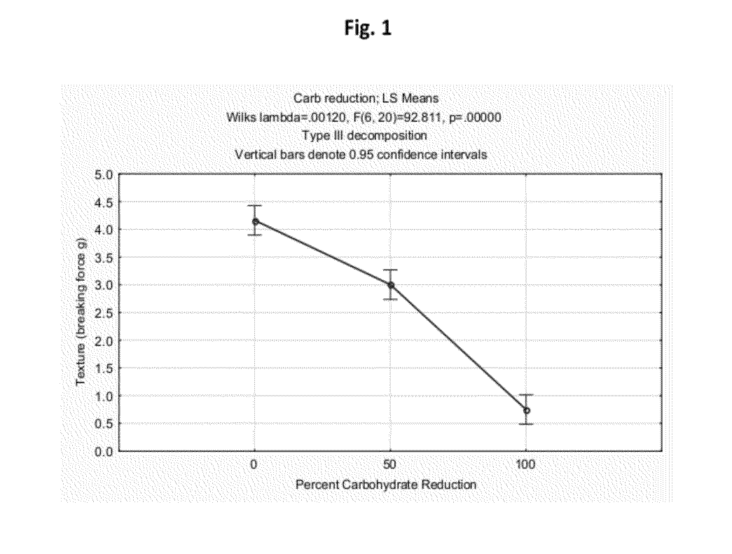

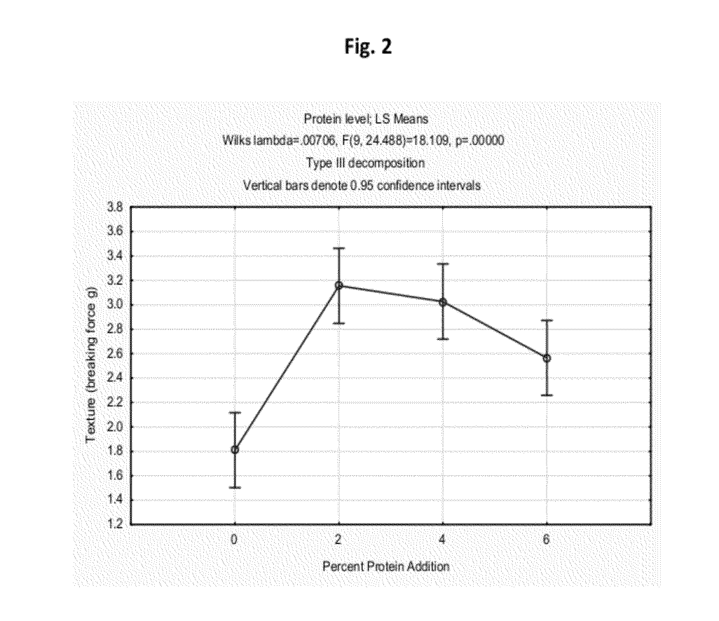

The Texture Analyzer measured the kg force to penetrate with a razor blade-like attachment. Graphs in FIG. 1 illustrate the breaking force required to break a cluster as carbohydrate is decreased and as carbohydrate is decreased, but protein is added (FIG. 2). As shown in FIG. 2, addition of less than 10% (by weight of the binder composition) of protein can protect the cluster from breakage when carbohydrate is reduced by as much as 50%.

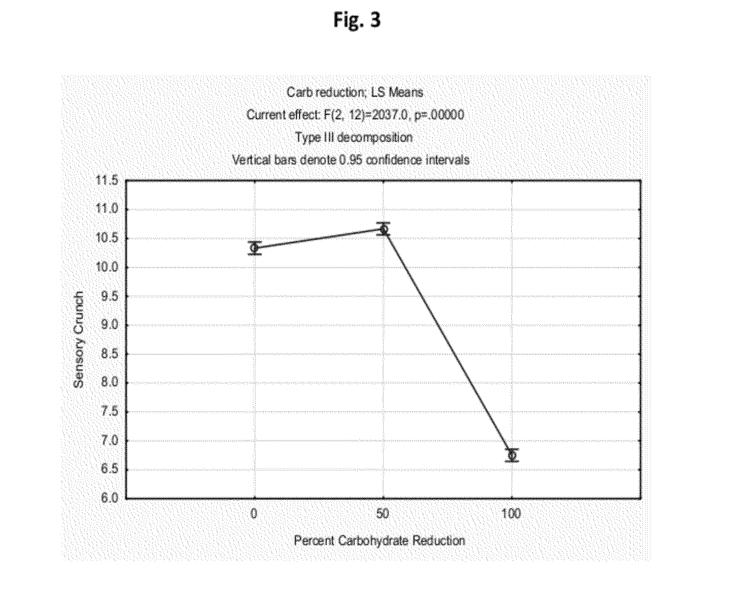

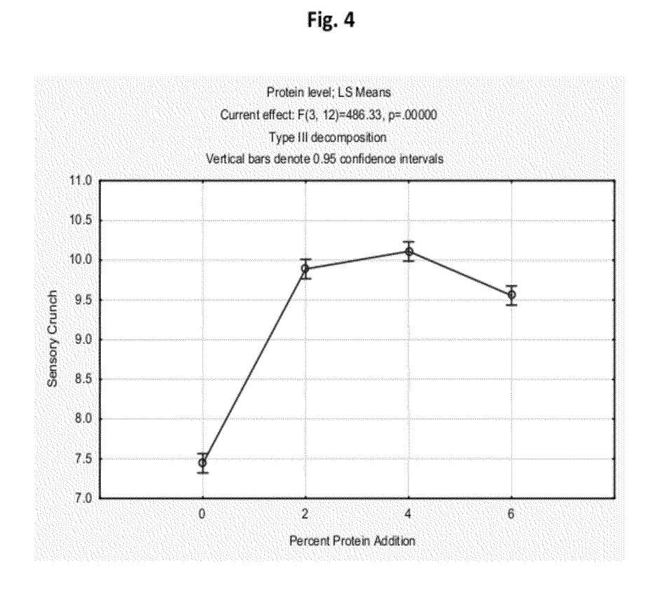

Graphs in FIG. 3 and FIG. 4 illustrate that sensory crunch is significantly decreased as carbohydrate levels in the binder are reduced (FIG. 3), but crunch can be maintained, even in the presence of carbohydrate reduction, by the addition of whey protein (FIG. 4).

### Example 1

### Production Method, Reduced Sugar Chewy Granola Bar

To produce a 25% reduced sugar chewy granola bar, honey, corn syrup, and water for corn syrup were heated to 120° F. Crystalline fructose, brown sugar, and salt were added with heating (to 120° F.) and stirring. Maltodextrin was added with heating (to 120°-130° Fahrenheit) and stirring, then oil was added with stirring until uniformly mixed. In a more preferred method, oil would be sprayed directly onto the cereal and omitted from the binder mix.

Protein (as milk protein concentrate) was gradually dusted into the top of a vortex in water heated to 120° F., using a lightning mixer. A 250 ml beaker, containing approximately 163 g of protein water, produces a vortex several inches high. Such larger volumes are recommended, as the mixture has a tendency to become viscous and the vortex is important for achieving good mixing.

The protein/water was combined with the sugar/water/oil and placed into a water bath (a double boiler or Groen Kettle may be used) and heated to 185° F. for 10 minutes, taking care to avoid water loss. The product was stirred every three minutes while held at a temperature of above 150 degrees Fahrenheit. The product was removed from the heat and cooled to below 150° F. (generally about 85 to 95 degrees Fahrenheit) then applied to a cereal base in a Hobart mixer. Care was taken not to mix for too long, avoiding grinding the cereal base. It is desirable for the mixture to tend to form some balls during the mixing.

The mixture was placed into forms and scored to produce bars. The tops of the bars were sprayed with a solution of 80% fructose/20% water to add shine. Bars were removed from the frame, cut, and packaged.

### Example 2

### Ingredients for a Baked Chocolate Almond Cherry Cereal Bar

Ingredients for a baked chocolate almond cherry cereal bar using a binder composition of the invention are shown in Table 3.

TABLE 3

| Ingredient | Weight in Grams |
|---|---|
| Kerry Toasted Oats | 89.4 |
| ConAgra 9-grain Cereal Crisp | 40 |
| Rice Krispies ® | 32 |
| ConAgra Coarse 8-grain and Seed | 25 |
| Blend | |
| Nuts, Almonds, Dried, | 18 |
| Unblanched | |
| Honey, amber | 10 |
| Syrup, brown, sweet (Sweet | 19.8 |
| Dreams) | |
| Brown Sugar | 21.7 |
| Baking Chips, Chocolate mini | 12 |
| Cherries, Tart, Dried | 14 |
| Canola Oil, spray | 19 |
| Sweetener, crystalline fructose | 0.7 |
| (Krystar ® 300) | |
| Water for fructose spray | 0.2 |
| Salt, fine TFC 999, pour/loose | 1.2 |
| Optisol 2000 ™ (Glanbia | 16 |
| Nutritionals) WPC | |
| Water | 31 |

### Example 3

### Ingredients for a Chewy Granola Bar

Table 4 lists the ingredients used in the production of a chewy granola bar using a binder composition of the invention.

TABLE 4

| | Weight in Grams for |
|---|---|
| | 35 g Batch Size Used |
| Ingredient | As Example |
| Kerry Toasted Oats | 11.28 |
| Cargill Corn Syrup 43/43 lX | 6.32 |
| Water, for corn syrup | 0.58 |
| Raisins, California seedless, fresh | 2 |
| Nuts, Almonds, Dried, Unblanched | 2.27 |
| Sweetener, fructose, crystalline | 0.8 |
| (Krystar ® 300) | |
| Honey, amber | 0.8 |
| Sugar, brown | 1.7 |
| Peanuts, dry-roasted | 1.6 |
| Cereal, Rice Krispies ® | 2.7 |
| Cranberries, dried, sweetened | 1.5 |
| Oil, Canola | 0.7 |
| Sweetener, fructose, crystalline, Krystar ® 300 | 0.2 |
| for spray | |
| Water for fructose spray | 0.05 |
| Sweetener, maltodextrin, lODE, MlOO | 1.4 |
| Salt, fine, TFC 999, pour/loose | 0.12 |
| OptiSol 2000 ™ Protein | 0.33 |
| Water | 0.64 |
| Mixed Tocopherols, Glanbia Nutritionals | 0.01 |

### Example 4

### Ingredients for Cereal Cluster Made with Puffed Cereal

Table 5 lists the ingredients used to make a 225 gram batch of cereal clusters using Kashi 7 Whole Grain Puffs cereal.

TABLE 5

| | 30% | | Binder | Binder |
|---|---|---|---|---|
| | Binder | Binder | Sugar | Water |
| | Percent | Grams | Grams | Grams |
| Evaporated Cane Juice Solids | 7.70 | 17.33 | 17.33 | |
| Water Needed for Cane Powder to | 3.71 | 0.00 | | 0.00 |
| make juice | | | | |
| Wildflower Honey | 3.81 | 8.57 | 6.53 | 1.60 |
| Brown Rice Syrup | 7.56 | 17.00 | 8.39 | 2.62 |
| Expellor Pressed Canola Oil | 6.96 | 15.65 | | |
| Soy Lecithin Solec WD | 0.26 | 0.59 | | |
| % Binder or g Binder | 30.00 | 59.15 | | |
| Kashi Puff g | | | | |
| Total Sugar | | | 33.63 | |
| Total Sugar per 32.5 g | | | 4.86 | |
| (Target 8-9 g) | | | | |
| Optisol g@ 2.21%/4.0%/5.15% of | 5.15 | 11.59 | 0.42 | 0.58 |
| total cereal + syrup | | | | |
| % Optisol of total Cereal Used | 5.15 | | | |
| Water needed for Optisol 32% | 10.94 | 24.62 | | |
| solids | | | | |
| Optisol and Water for Optisol | | 36.21 | | |
| Subtotal with Optisol and Optisol | | 95.36 | | |
| water | | | | |
| Soluble Corn Fiber to make | 21.19 | 47.68 | 0.95 | 13.35 |
| difference to 225 g | | | | |
| Syrup Total Above: | 63.57 | 143.04 | | |
| Kashi Puff g in 100 | 36.43 | 81.96 | | |
| Original Syrup Components g in | 30.0 | | | |
| 100 | | | | |
| Final Kashi Pugg in 100 g | 36.43 | | | |
| Original Syrup + Optisol/Corn | 63.57 | 143.04 | | |
| Fiber | | | | |
| Total Syrup & Puffs: | | 225.0 | | |
| % Syrup/Including Corn Fiber & | | 63.57% | | |
| Optisol 2000 | | | | |
| % Water Added From Ingredients: | | | | 8.06 |

### Example 5

### Cereal Bar with 5 g Sugar

Table 6 lists the ingredients used to make a cereal bar comprising 5 grams of sugar.

TABLE 6

| | Grams | | Percent |
|---|---|---|---|
| Item Name | Ingredient | | Water |
| Granola Mix | 8.74 | | |
| Cereal, Crispy Brown Rice | 2.1 | | |
| Baking Chips, chocolate, semi-sweet, | 1.8 | | |
| mini | | | |
| Coconut, dried, unsulfured, unsweetened, | 0.5 | | |
| shred | | | |
| Cargill Corn Syrup 43/43 IX | 5.5 | | 1.06865 |
| Water, Municipal | 0.4 | | 0.4 |
| Sweetener, fructose, crystalline, Krystar | 0.1 | | |
| 300 | | | |
| Honey, amber | 0.1 | | 0.015 |
| Maltisweet MH65 Maltitol | 2 | | 0.5 |
| Sugar, brown | 0.1 | | |
| Sunflower Oil | 0.43 | | |
| Sweetener, fructose, crystalline, Krystar | 0.136 | | |
| 300 | | | |
| Water for Fructose spray | 0.034 | | |
| Sweetener, maltodextrin, 10DE, M100 | 1.2 | | |
| Salt, fine, TFC 999, pour/loose, f/all other | 0.11 | | |
| plants | | | |
| Optisol ® 2000 | 0.226 | | |
| Water, Municipal | 0.42 | | 0.42 |
| Mixed Tocopherols Glanbia | 0.004 | | 2.40365 |
| Danisco Natural Vanilla Extract WONF | 0.1 | | |
| C21633 | | | |
| Totals: | 24 | grams | |

What is claimed is:

1. A substantially gluten-free cereal binder composition comprising whey protein and carbohydrate.

2. The composition of claim 1 wherein the binder composition is substantially fat-free.

3. The composition of claim 1 wherein the whey protein comprises from about 0.2 percent to about 6 percent of the composition, by weight.

4. The composition of claim 1 wherein the whey protein comprises from about 0.5 percent to about 9 percent of the composition, by weight.

5. The composition of claim 1 wherein the carbohydrate further comprises at least one sugar.

6. A method for reducing the amount of carbohydrate needed to maintain cluster strength in an agglomerated cereal product, the method comprising adding to a cereal binder a substantially gluten-free protein at a level of from about 0.2 percent to about 6 percent of the total weight of the agglomerated cereal product.

7. The method of claim 6 wherein the substantially gluten-free protein is whey protein.

8. The method of claim 6 wherein the whey protein is selected from the group consisting of whey protein concentrate, whey protein isolate, and combinations thereof.

9. The method of claim 6 wherein the substantially gluten-free protein is soy protein.

10. A method for making an agglomerated cereal product, the method comprising admixing at least one cereal product with a binder composition comprising at least one substantially gluten-free protein and at least one carbohydrate, wherein the binder composition is substantially fat-free and substantially gluten-free.

11. The method of claim 10 further comprising a first step comprising applying oil or fat to the surface of the at least one cereal product to be incorporated into the agglomerated cereal product, the amount of oil or fat effective to limit absorption of the binder composition into the cereal product.

12. The method of claim 10 wherein the at least one carbohydrate comprises at least one sugar.

13. The method of claim 10 wherein the at least one substantially gluten-free protein is chosen from among whey protein, milk protein soy protein, and combinations thereof.

14. A method for making a binder for chewy clustered cereal products, the method comprising the steps of hydrating whey protein at a level of about 25 to about 35 percent protein in water, and admixing the hydrated whey protein with at least one sugar syrup to produce a mixture having a viscosity solids range of from about 65 to about 85 percent.

15. The method of claim 14 wherein the sugar solids range is from about 70 to about 78 percent.

16. The method of claim 14 wherein the step of hydrating whey protein further comprises dissolving the protein in water at a temperature of from about 70° to 140° F. and admixing the hydrated protein with a sugar syrup at a temperature of from about 70° to 140° F.

17. A method for improving the shelf-life, texture, and palatability of chewy cereal products, the method comprising incorporating into a sugar syrup binder at least one hydrated milk protein.

18. The method of claim 17 wherein the at least one hydrated milk protein comprises at least one hydrated whey protein.
